(19) United States
(12) Patent Application Publication
(10) Pub. No.: US 2016/0272807 A1
(43) Pub. Date: Sep. 22, 2016

(54) Polyoxymethylene Nanoparticles

(71) Applicant: Ticona GmbH, Sulzbach (DE)

(72) Inventors: Michael Haubs, Bad Kreuznach (DE); Klaus Kurz, Kelsterbach (DE); Markus B. Bannwarth, Mainz (DE); Katharina Landfester, Mainz (DE); Frederik R. Wurm, Mainz (DE); Holger Frey, Mainz (DE); Rebecca Klein, Mainz (DE)

(21) Appl. No.: 15/074,534

(22) Filed: Mar. 18, 2016

Related U.S. Application Data
(60) Provisional application No. 62/135,955, filed on Mar. 20, 2015.

(51) Int. Cl. C08L 59/04; C08G 2/08; C08G 2/22; C08L 59/02

(52) U.S. Cl. CPC C08L 59/04; C08L 59/02; C08G 2/08; C08G 2/22; C08L 2201/54

(57) ABSTRACT

The synthesis of nanoparticles based on hyperbranched-linear-hyperbranched ABA triblock copolymers with hyperbranched polyglycerol (hbPG) as A-block and linear poly(oxymethylene) as B-block is described. The acid-degradable nanoparticles were formed in a facile process, combining a solvent evaporation process with the miniemulsion technique resulting in particles with a diameter in the range of 190 to 250 nm and a standard deviation of ˜30% determined with DLS and SEM. The nanoparticles were placed on a silicon wafer and sintered leading to films with a thickness in the μm-range investigated via SEM. The surface properties of these films were investigated via static contact angle measurements at the liquid/vapor interface. The contact angle decreases from 67° for the polymer with two hydroxyl groups to 29° for the polymer with 16 hydroxyl groups, confirming the influence of the polymer structure and size of the hbPG block on the surface properties.

### RELATED APPLICATIONS

The present application is based on and claims priority to U.S. Provisional Patent Application Ser. No. 62/135,955, filed on Mar. 20, 2015, which is incorporated herein by reference.

### BACKGROUND

Polyoxymethylene is an exceptional material due to its excellent mechanical properties, such as high tensile strength and remarkable impact strength, which result in part from the high degree of crystallization. A drawback of these properties is the high insolubility of the polymer in organic solvents and water, which can complicate the handling of polyoxymethylene polymers. Polyoxymethylene homopolymer, also called polyacetal, comprises only repeating carbon-oxygen linkages and therefore is temperature and acid labile and degrades slowly with the release of formaldehyde. In contrast, polyoxymethylene copolymers produced by cationic ring-opening polymerization of 1,3,5-trioxane and other cyclic ethers, such as ethylene oxide, 1,3-dioxolane and 1,3-dioxepane, are more temperature stable. Due to the molecular structure, copolymers have greater thermal stability but a reduced degree of crystallization, because of the interruption of the carbon-oxygen linkages with carbon-carbon units.

Although polyoxymethylene polymers have excellent thermal stability, physical properties, and chemical resistance, a need exists for a process for producing polyoxymethylene polymers in a form that allows the polymers to be used in new and diverse applications. For instance, a need exists for a process for producing small particles of a polyoxymethylene polymer in a dispersion that allows the polymers not only to be easily handled but also provides the opportunity for use in new applications. Such particles, for instance, may be used to form films, emulsions, and the like and may have increased hydrophilic properties.

### SUMMARY

In general, the present disclosure is directed to a process for producing particles of polyoxymethylene polymers. In one embodiment, polyoxymethylene nanoparticles may be produced. The particles can be produced in a suspension, such as an aqueous suspension. The particles have various uses. For instance, the polyoxymethylene particles can be used as additives for emulsions, can be used in 3D printing and can also be used in various powder coating applications. The particles may also be used to form films, such as very thin films. In one embodiment, a hyperbranched polyoxymethylene polymer may be used to produce the particles, which imparts the particles with hydrophilic properties.

In one embodiment, the present disclosure is directed to polymer particles comprising polyoxymethylene nanoparticles. The nanoparticles can have an average particle size of from about 20 nm to about 700 nm as measured by dynamic light scattering. For instance, the nanoparticles can have an average particle size of from about 50 nm to about 500 nm. The nanoparticles can be made solely from a polyoxymethylene polymer.

The polyoxymethylene polymer used to produce the nanoparticles can vary depending upon the particular application. In one embodiment, the nanoparticles comprise a polyoxymethylene polymer having a number average molecular weight of from about 500 g/mol to about 50,000 g/mol, such as from about 500 g/mol to about 20,000 g/mol. The polyoxymethylene polymer may comprise a polyoxymethylene copolymer.

In one particular embodiment, the nanoparticles comprise a polyoxymethylene triblock copolymer. The triblock copolymer can include a middle portion between a first end portion and a second end portion. The first and second end portions may comprise hyperbranched portions. For instance, the first and second end portions can include at least 10 branches per molecule and up to about 500 branches per molecule. The first and second end portions may comprise hyperbranched polyglycerol, while the middle portion may comprise a linear structure having repeating oxymethylene units and optionally other oxyalkylene units.

In one embodiment, the nanoparticles may be contained in a dispersion, such as an aqueous dispersion.

In order to form nanoparticles in accordance with the present disclosure, a polyoxymethylene polymer may be dissolved in a solvent to form a solution. The polyoxymethylene solution can be combined with an emulsifying liquid to form an emulsion. The emulsifying liquid is immiscible with the solvent. The solvent can then be evaporated to leave a dispersion containing polyoxymethylene nanoparticles.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a diagram illustrating one embodiment of a process for producing polyoxymethylene particles in accordance with the present disclosure; and

FIG. 2 is a graphical representation of results obtained in the example described below.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to polyoxymethylene particles and to a process for making the particles. In accordance with the present disclosure, particles that are made entirely of a polyoxymethylene polymer can be produced that have diameters in the sub-micron range. Such particles can be used in numerous and diverse applications, even applications that were not generally amenable to polyoxymethylene polymers in the past. The sub-micron particles, for instance, may be used in emulsions and in powder coating applications. In addition, in one embodiment, a hyperbranched polyoxymethylene polymer may be used to produce the particles resulting in particles having increased hydrophilic properties. In one particular embodiment, the polyoxymethylene particles may be used in 3-dimensional printing applications.

In order to produce polyoxymethylene particles in accordance with the present disclosure, a polyoxymethylene polymer is first dissolved in a solvent. The resulting homogeneous solution is then dispersed in a liquid which is immiscible with the solvent. An emulsion is formed. In one embodiment, the emulsion is formed with the aid of a detergent and/or with ultrasonic energy. The emulsion can be used to control the particle size of the resulting polymer. After the emulsion is produced, the solvent is evaporated leaving the polymer particles behind dispersed in the liquid. In one embodiment, the particles can be redispersed in an aqueous solution, such as water.

The polyoxymethylene polymer used to produce the particles can vary depending upon the particular application and the desired result. In one embodiment, the polyoxymethylene polymer may have a relatively low molecular weight. For instance, the polyoxymethylene polymer may have a number average molecular weight of less than about 50,000 g/mol, such as less than about 40,000 g/mol, such as less than about 30,000 g/mol, such as less than about 20,000 g/mol, such as less than about 15,000 g/mol, such as less than about 10,000 g/mol. The number average molecular weight is generally greater than about 500 g/mol.

The polyacetal resin may comprise a homopolymer or a copolymer and can include end caps. The homopolymers may be obtained by polymerizing formaldehyde or trioxane, which can be initiated cationically or anionically. The homopolymers can contain primarily oxymethylene units in the polymer chain. Polyacetal copolymers, on the other hand, may contain oxyalkylene units along side oxymethylene units. The oxyalkylene units may contain, for instance, from about 2 to about 8 carbon units and may be linear or branched. In one embodiment, the homopolymer or copolymer can have hydroxy end groups that have been chemically stabilized to resist degradation by esterification or by etherification.

The homopolymers are generally prepared by polymerizing formaldehyde or trioxane, preferably in the presence of suitable catalysts. Examples of particularly suitable catalysts are boron trifluoride and trifluoromethanesulfonic acid.

Polyoxymethylene copolymers can contain alongside the —CH₂O— repeat units, up to 50 mol %, such as from 0.1 to 20 mol %, and in particular from 0.5 to 10 mol %, of repeat units of the following formula

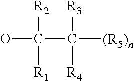

where R¹ to R⁴, independently of one another, are a hydrogen atom, a C₁-C₄-alkyl group, or a halo-substituted alkyl group having from 1 to 4 carbon atoms, and R⁵ is —CH₂—, —O—CH₂—, or a C₁-C₄-alkyl- or C₁-C₄-haloalkyl-substituted methylene group, or a corresponding oxymethylene group, and n is from 0 to 3.

These groups may advantageously be introduced into the copolymers by the ring-opening of cyclic ethers. Preferred cyclic ethers are those of the formula

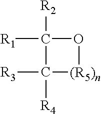

where R¹ to R⁵ and n are as defined above.

Cyclic ethers which may be mentioned as examples are ethylene oxide, propylene 1,2-oxide, butylene 1,2-oxide, butylene 1,3-oxide, 1,3-dioxane, 1,3-dioxolane, and 1,3-dioxepan, and comonomers which may be mentioned as examples are linear oligo- or polyformals, such as polydioxolane or polydioxepan.

Use is also made of oxymethyleneterpolymers, for example those prepared by reacting trioxane with one of the abovementioned cyclic ethers and with a third monomer, preferably a bifunctional compound of the formula

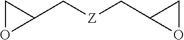

where Z is a chemical bond, —O— or —ORO—(R═C₁-C₈-alkylene or C₂-C₈-cycloalkylene).

Preferred monomers of this type are ethylene diglycide, diglycidyl ether, and diethers composed of glycidyl units and formaldehyde, dioxane, or trioxane in a molar ratio of 2:1, and also diethers composed of 2 mol of glycidyl compound and 1 mol of an aliphatic diol having from 2 to 8 carbon atoms, for example the diglycidyl ethers of ethylene glycol, 1,4-butanediol, 1,3-butanediol, 1,3-cyclobutanediol, 1,2-propanediol, or 1,4-cyclohexene diol, to mention just a few examples.

Polyacetal resins as defined herein can also include end capped resins. Such resins, for instance, can have pendant hydroxyl groups. Such polymers are described, for instance, in U.S. Pat. No. 5,043,398, which is incorporated herein by reference.

The processes used to form the polyoxymethylene polymers as described above can vary depending upon the particular application. A process, however, can be used which results in a polyacetal resin having a relatively low formaldehyde content. In this regard, in one embodiment, the polymer can be made via a solution hydrolysis process as may be described in U.S. Patent Application Publication Number 2007/0027300 and/or in United States Patent Application Number 2008/0242800, which are both incorporated herein by reference. For instance, in one embodiment, a polyoxymethylene polymer containing aliphatic or cycloaliphatic diol units can be degraded via solution hydrolysis by using methanol and water with triolethylene.

Polyacetal resins or polyoxymethylenes that may be used in accordance with the present disclosure generally have a melting point of greater than about 150 degrees C. The polymer can have a meltflow rate (MVR 190-2.16) from about 0.3 to about 50 g/10 min, and particularly from about 2 to about 20 g/10 min (ISO 1133).

In one embodiment, the polyoxymethylene polymer may comprise a hyperbranched polyoxymethylene polymer. The hyperbranched polymer can include a middle portion or core portion that comprises a polyoxymethylene homopolymer or copolymer. For example, the middle portion may comprise oxymethylene repeat units alone or in combination with other oxyalkylene units, such as oxyethylene units. The polymer may include at least one end portion that has a hyperbranched structure. In one embodiment, the core portion made from a polyoxymethylene polymer is grafted at one end to a hyperbranched structure and grafted at an opposite end to another hyperbranched structure.

The hyperbranched structures provide the polymer with a large number of end groups. The different end groups can be attached to the polymer for providing the polymer with various properties. In one embodiment, for instance, the hyperbranched polymer may include a significant number of hydroxy end groups. The hydroxy end groups can provide reactive sites for grafting, coupling, or otherwise attaching the polymer to other compounds. The hydroxy end groups may also increase the hydrophilic properties of the polymer.

In addition to hydroxyl groups, various other functional groups can be incorporated into the hyperbranched structure of the polyoxymethylene polymer. The functional groups may occupy greater than about 20% of all the terminal groups present on the polymer, such as greater than about 30%, such as greater than about 40%, such as greater than about 50%, such as greater than about 60%, such as greater than about 70%, such as even greater than about 80% of all the terminal groups on the polymer. The functional groups, for instance, can occupy up to 100% of the terminal groups on the polyoxymethylene polymer molecule.

In one embodiment, the hyperbranched polyoxymethylene polymer of the present disclosure may be amphiphilic. In particular, the polyoxymethylene core portion of the polymer may be hydrophobic, while the highly branched structures may be hydrophilic.

Another property that may be improved by the presence of the hyperbranched structure in the polyoxymethylene polymer is the solubility of the polymer. The hyperbranched structure, for instance, may make the polymer more soluble in some solvents, such as organic solvents.

In order to produce hyperbranched polyoxymethylene polymers in accordance with the present disclosure, in one embodiment, a hydroxy terminated polyoxymethylene polymer or oligomer is at least partially deprotonated. The polyoxymethylene polymer may comprise a polyoxymethylene homopolymer or a polyoxymethylene copolymer. For example, in one embodiment, the polyoxymethylene polymer may have a linear structure having repeating oxymethylene units and other oxyalkylene units, such as oxyethylene units.

In order to partially deprotonate the polyoxymethylene polymer or oligomer, the polymer is contacted with a base while water is removed. In one embodiment, a strong base is used. The strong base, for instance, may comprise a hydroxide, such as a metal hydroxide. For instance, the base may comprise cesium hydroxide, potassium hydroxide, sodium hydroxide, or mixtures thereof. Strong organic bases may also be used. An example of a strong organic base is a bicyclic guanidine. Besides guanidines, various other nitrogen-containing organic bases can be used including phosphazenes or amidines, as long as the organic base does not adversely affect the properties of the polyoxymethylene polymer.

Once the polyoxymethylene polymer or oligomer is at least partially deprotonated, the deprotonated polyoxymethylene is then reacted with a multi-functional hyperbranching monomer. The multi-functional hyperbranching monomer grafts to the polymer or oligomer and then further polymerizes to form a polyoxymethylene polymer with a hyperbranched portion.

In one embodiment, the process for producing the hyperbranched polyoxymethylene polymer may be represented as follows:

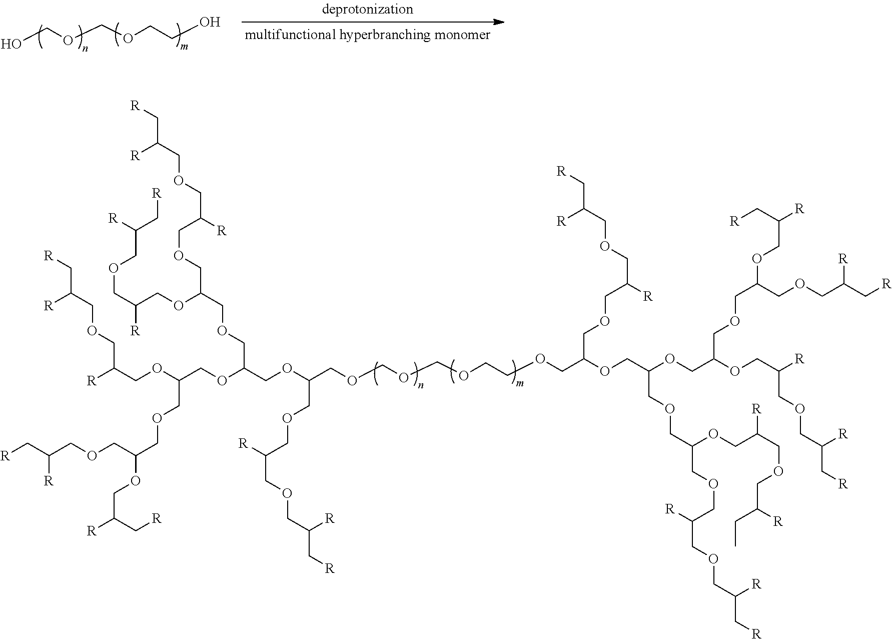

As shown above, the hyperbranched polyoxymethylene polymer includes a middle portion positioned in between a first end portion and a second end portion. In the embodiment above, both end portions have a hyperbranched structure.

The middle portion in the embodiment above comprises a linear polyoxymethylene copolymer. In one embodiment, the polyoxymethylene copolymer can be produced by polymerizing trioxane with 1,3-dioxolane. The end portions having the hyperbranched structure can include multiple ether linkages. In addition, the hyperbranched structures can include terminal groups R. The terminal groups R may comprise the same groups or different groups. In one embodiment, the terminal groups comprise functional groups. Functional groups that may be incorporated into the polymer include hydroxy groups, amino groups, alkoxyl groups, esters or amides.

As shown above, the hyperbranched structures include a significant number of branches and therefore a significant number of terminal groups. For instance, each hyperbranched portion on the polymer molecule may have at least 10 branches, such as at least 15 branches, such as at least 20 branches, such as at least 25 branches, such as at least 30 branches, such as at least 35 branches, such as at least 40 branches, such as at least 45 branches, such as at least 50 branches. In general, each hyperbranched portion will have less than about 500 branches, such as less than about 400 branches, such as less than about 300 branches.

Depending upon the multi-functional hyperbranching monomer used to produce the hyperbranched polymer, in one embodiment, a triblock copolymer can be produced. The triblock copolymer may have an ABA structure in which the A units are the repeating units that make up the hyperbranched portion while the B units comprise the oxymethylene units. In the embodiment illustrated above, the hyperbranched portions are aliphatic.

The multi-functional hyperbranching monomer is generally any suitable multi-functional monomer capable of grafting to the polyoyxmethylene polymer chain while also producing a hyperbranched structure. In one embodiment, for instance, the multi-functional hyperbranching monomer may comprise glycidol. Glycidol includes an epoxy group in conjunction with a CH₂OH group.

In one particular embodiment, when using glycidol as the multi-functional hyperbranching monomer, the reaction sequence for producing a hyperbranched polyoxymethylene polymer is illustrated below.

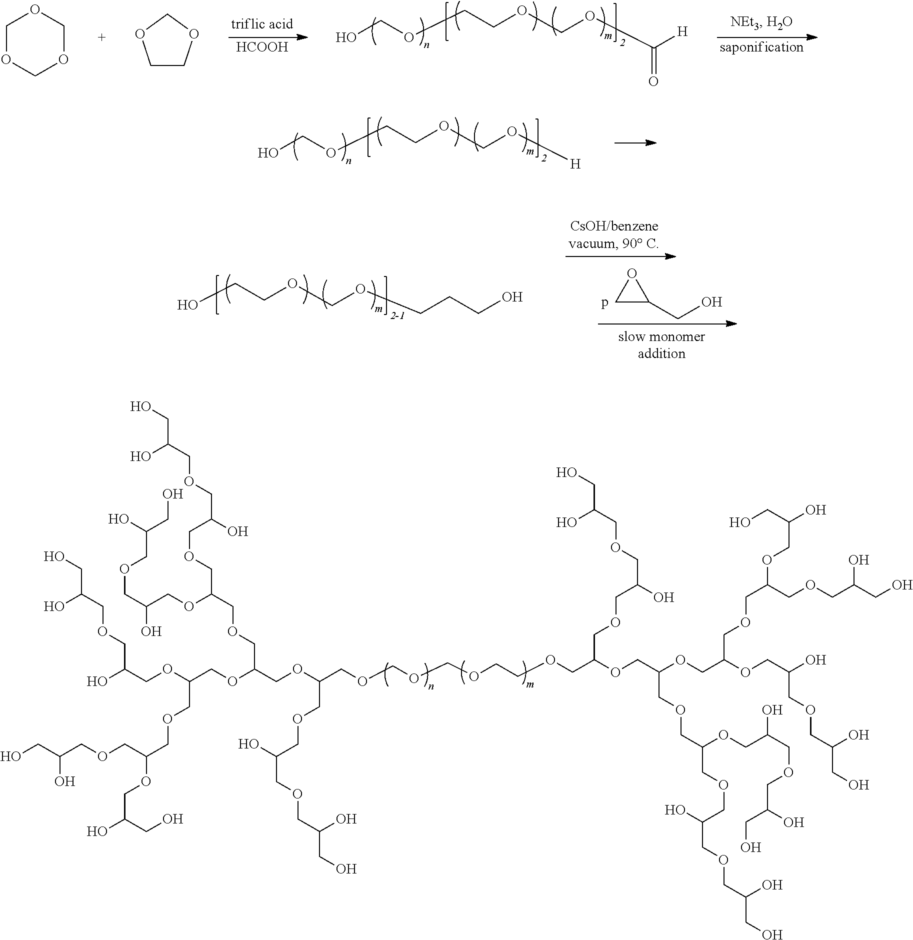

In the first step, linear bishydroxyalkylfunctional poly(oxy methylene) polymer was prepared by cationic ring-opening polymerization of trioxane and dioxolane with formic acid as a transfer agent. The resulting formate end groups were hydrolyzed to obtain the bishydroxy end-functional POM, which serves as a macroinitiator for the ensuing hypergrafting reaction of glycidol to build up the two hyperbranched blocks. The high stability of the POM macroinitiators ensures chemical stability during the basic conditions of the anionic ring-opening multibranching polymerization (ROMBP) of glycidol. To prepare the reactive initiator for the ROMBP, the hydroxyl groups of POM were partially deprotonated (10 mol %) using cesium hydroxide. As shown above, only one hydroxyl group at each chain end can serve as initiator. This is due to the crystalline structure of POM, where the functional end groups always stick out of the surface of the crystal and thereby can be addressed by the glycidol monomers. In some embodiments, the molecular weight of the hbPG-blocks can be limited on each side of the POM macroinitiator. This is due to the increasing viscosity of the products and the low number of alkoxide end groups at high degree of polymerization. For instance, in some embodiments, the molecular weight of the hyperbranched polyglycerol blocks can be less than about 6,000 g/mol, such as less than about 5,000 g/mol. In other embodiments, however, higher molecular weight end blocks may be possible.

In order to produce the hyperbranched portions, the multi-functional hyperbranching monomer may be added gradually to the polyoxymethylene polymer or oligomer that serves as the macroinitiator. The amount of monomer added to the macroinitiator can vary depending upon the particular application and the particular monomer used. In general, the weight ratio of the macroinitiator (deprotonated polymer) to the multi-functional hyperbranched monomer is from about 1:0.1 to about 1:10, such as from about 1:0.5 to about 1:5.

In the embodiment described above, the polyoxymethylene polymer or oligomer that undergoes deprotonization includes terminal hydroxy groups. The polyoxymethylene preferably has terminal hydroxyl groups, for example hydroxyethylene groups (—OCH₂CH₂—OH) and hemi-acetal groups (—OCH₂—OH). According to one embodiment, at least 50%, more preferably at least 75% of the terminal groups of the polyoxymethylene are hydroxyl groups, especially hydroxyethylene groups.

The content of hydroxyl groups end groups is especially preferred at least 80%, based on all terminal groups. The term “all terminal groups” is to be understood as meaning all terminal and—if present—all side terminal groups. As described above, in one embodiment, the polyoxymethylene polymer or oligomer comprises a bis-hydroxy polyoxymethylene.

In addition to the terminal hydroxyl groups, the POM may also have other terminal groups usual for these polymers. Examples of these are alkoxy groups, formate groups, acetate groups or aldehyde groups. According to a preferred embodiment of the present invention the polyoxymethylene (A) is a homo- or copolymer which comprises at least 50 mol-%, preferably at least 75 mol-%, more preferably at least 90 mol-% and most preferably at least 95 mol-% of —CH₂O-repeat units.

The polyoxymethylene generally can have a melt volume rate MVR of less than 1000 cm³/10 min, preferably ranging from 1 to 500 cm³/10 min, further preferably ranging from 1 to 200 cm³/10 min, more preferably ranging from 1 to 100 cm³/10 min, determined according to ISO 1133 at 190° C. and 2.16 kg.

The polyoxymethylene can have a content of terminal hydroxyl groups of at least 5 mmol/kg, preferably at least 10 mmol/kg, more preferably at least 50 mmol/kg and most preferably ranging from 50 to 500 mmol/kg.

The content of terminal hydroxyl groups can be determined as described in K. Kawaguchi, E. Masuda, Y. Tajima, Journal of Applied Polymer Science, Vol. 107, 667-673 (2008).

The hydroxy functional POM, in accordance with the present disclosure, is partially deprotonized and then reacted with a multi-functional hypergrafting monomer in order to form hyperbranching structures on the polymer molecule. The hyperbranching structures can be initiated at a hydroxy end group. In one embodiment, the resulting polyoxymethylene polymer may include a hyperbranched structure at one end of the polymer or at both ends of the polymer.

Hyperbranched polyoxymethylene polymers made in accordance with the present disclosure can be produced to have different properties. For instance, depending upon the monomers used and the macroinitiator, low molecular weight polymers or high molecular weight polymers can be produced. In one embodiment, for instance, a low molecular weight polymer may be produced that has a molecular weight of less than about 10,000 g/mol, such as less than about 8,000 g/mol. In general, the molecular weight is greater than about 1,000 g/mol. In other embodiments, the molecular weight may be greater than about 10,000 g/mol, such as greater than about 20,000 g/mol, such as greater than about 25,000 g/mol, such as greater than about 30,000 g/mol, such as greater than about 35,000 g/mol, such as greater than about 40,000 g/mol. The polydispersity (M_{w}/Mₙ) of the polymer can be relatively narrow. For instance, the polydispersity can be in the range of from about 1.3 to about 1.9.

Once a polyoxymethylene polymer is selected in accordance with the present disclosure, the polymer is dissolved in a solvent to form a polyoxymethylene solution. In general, any suitable solvent may be used that is capable of dissolving the polyoxymethylene polymer and later forming an emulsion. In one embodiment, the solvent comprises an alcohol or a fluorinated solvent. For instance, the alcohol may comprise hexafluoro-2-isopropanol and is preferred.

In general, any suitable solvent for a polyoxymethylene polymer may be used. In one embodiment, increased pressure and/or heat may be used in order to ensure that the polymer dissolves in the solvent. The pressure, for instance, may be from about 1.25 atm to about 5 atm, such as from about 1.5 atm to about 3 atm. Other solvents that may be considered for use in the present process include dimethylacetamide, N-methyl-2-pyrrolidone, dimethylformamide, butyrolacton, or mixtures thereof.

The polyoxymethylene polymer is combined with the solvent with sufficient solvent present to form a solution and to dissolve substantially all of the polymer. Various different techniques may be used in order to facilitate formation of the solution. For instance, in one embodiment, heat and/or pressure can be applied to the mixture as long as the solvent does not volatilize. In one embodiment, the mixture can be subjected to ultrasonic energy. In one embodiment, for instance, the polymer and solvent mixture can be sonicated at a temperature of from about 25° C. to about 45° C., such as from about 28° C. to about 35° C.

Once the polymer solution is formed, the solution is combined with an emulsifying liquid to form an emulsion. In general, the emulsifying liquid is any suitable liquid that is immiscible with the solvent or polymer solution. In one embodiment, the emulsifying liquid may comprise cyclohexane. Other emulsifying liquids comprise acyclic hydrocarbons, like hexane or octane or mixtures thereof, provided they are not miscible with the solvent for POM.

In one embodiment, in order to form an emulsion, the polymer solution is not only combined with an emulsifying liquid but also an emulsifying agent, such as a surfactant or detergent. In general, any suitable surfactant may be used. For instance, in one embodiment, the surfactant or emulsifying agent may comprise poly[(ethylene-co-butylene)-b-(ethylene oxide)].

Once the polymer solution is combined with the emulsifying liquid and optionally an emulsifying agent, the resulting mixture can be mixed under conditions sufficient to form a mini-emulsion. For instance, in one embodiment, the liquid mixture can be sonicated while being cooled.

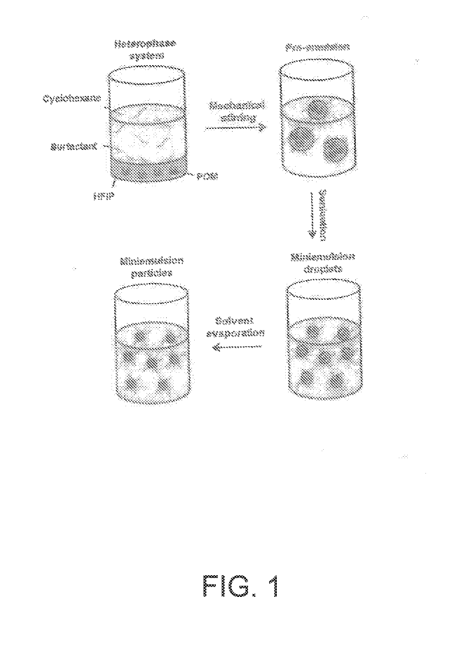

After the emulsion is formed, the solvent can be evaporated leaving behind polyoxymethylene polymer particles. After evaporation of the solvent, a nanoparticle dispersion remains. The dispersion comprises polyoxymethylene polymer particles contained in the emulsifying liquid, such as cyclohexane. Referring to FIG. 1, a diagram showing preparation of the polyoxymethylene polymer particles is illustrated. By mechanical stirring and ultrasonication, mini-emulsion droplets are formed. By solvent evaporation, the droplets are transformed into solid polyoxymethylene polymer nanoparticles. A dispersion of polyoxymethylene particles in the emulsifying liquid are obtained.

The size of the polyoxymethylene particles are generally less than one micron. Particle size can be measured by dynamic light scattering. In general, the average particle size of the polymer particles can be from about 20 nm to about 700 nm, such as from about 50 nm to about 500 nm.

In one embodiment, the polyoxymethylene particles can be redispersed in an aqueous solution. For instance, in one embodiment, the resulting dispersion can be combined with water. After being combined with water, the emulsifying liquid can be evaporated leaving behind an aqueous dispersion of the particles.

Once in an aqueous dispersion, the particles can be used in numerous and diverse applications. In one embodiment, the particles may be used to form a film.

The present disclosure may be better understood with reference to the following example.

### EXAMPLE

In the following example, a linear polyoxymethylene polymer (“POM”) and nonlinear ABA triblock copolymers containing a linear POM block and hyperbranched poly(glycerol) (hbPG) blocks were used in a miniemulsion/solvent evaporation protocol to obtain nanoparticles comprised of a POM copolymer and hbPG-b-POM-b-hbPG copolymers. Various degrees of polymerization of hbPG were studied with respect on tailoring the hydrophilicity of the resulting polymeric nanoparticles. The particle dispersion was drop-casted and sintered onto a silicon surface and investigated via static contact angle measurements and a high influence of the hbPG-segments on the hydrophilicity of the POM surface was detected. Organic or aqueous miniemulsions of the POM nanoparticles can be used for surface applications, e.g., in coatings and sintering results in film formation while retaining the excellent mechanical properties of POM, which is of great interest for shock proofed surfaces.

### Instrumentation.

¹H NMR spectra were recorded at 600 MHz at 37° C. on a Bruker Avance III and are referenced internally to residual proton signals of the deuterated solvent. SEC measurements in HFIP containing 0.05 mol L⁻¹ KFAc were performed on a Jasco LC-NetII/ADC as an integrated instrument including a PS PFG 100 A column and a RI detector. Poly(methyl methacrylate) provided by Polymer Standards Service was used as calibration standard. DSC measurements were carried out on a Perkin-Elmer DSC 8500 in the temperature range of −95 to 180° C. in two heating runs, using heating rates of 10 K min⁻¹ under nitrogen. The hydrodynamic radius of the POM-nanoparticles was determined via DLS measurements on a NICOMP Zetasizer at a measurement angle of 90°. The dispersion after particle formation was diluted with cyclohexane (1:50) and measured at 25° C. Scanning electron microscopy (SEM) was performed on a Hitachi SU8000 at an extractor voltage of 3.0 kV. To form a miniemulsion, a ½ inch tip Branson Sonifier W-450-Digital was used. Contact angle measurements were performed on a Dataphysics Contact Angle System OCA using MilliQ-water as interface agent.

### Materials

Trioxane, 1,3-dioxolane and triflic acid were obtained from Ticona GmbH. Cesium hydroxide monohydrate and 1,1,1,3,3,3-hexafluoro-2-isopropanol-d₂ (HFIP-d₂) were purchased from Acros. Methanol, cyclohexane, benzene and sodium dodecyl sulfate (SDS) were obtained from Sigma-Aldrich and HFIP from Apollo Scientific Limited. Glycidol and dimethylacetamide (DMAc) (99% Acros) were purified by distillation from CaH₂ prior to use. The surfactant KLE (poly[(ethylene-co-butylene)-b-(ethylene oxide)] with M_{w}=3,700 g·mol⁻¹ for P(E/B) and M_{w}=3,600 g·mol⁻¹ for PEO) was synthesized.

Synthesis of poly(oxymethylene) (POM) and the ABA Triblock Copolymers (hbPG-b-POM-b-hbPG)

The synthesis of POM and the corresponding ABA triblock copolymers was performed as described above. For the synthesis of the linear poly(oxymethylene) block, trioxane (100 g, 1.11 mol) was preheated to 80° C. and dioxolane (10 g, 0.13 mol) and formic acid (1.8 g, 0.04 mol) was added and the reaction mixture was stirred vigorously. Triflic acid was added and the resulting polymer dissolved in NMP (1.5 L) at 150-160° C., triethylamine (1.5 mL) and water (1.0 mL) were added and heated to 100° C. After 30 min the water was removed by distillation and the solution was again heated to 140° C. for 2 h. Then the mixture was allowed to cool down to 65° C. and filtrated to remove low molecular weight side-products. The filter cake was diluted in methanol and again heated to 70° C. for 1 h. After filtration of the mixture, the filter cake was dried in vacuo (yield: 53%). SEC (HFIP, PMMA-Std.): Mₙ=10 700 g mol⁻¹; PDI=2.09. ¹H NMR (HFIP-d₂, 600 MHz): δ [ppm]=5.20-5.00 (—CH₂— polymer main chain); 5.00-4.95 (—CH₂— dioxolane); 3.95-3.90 (—CH₂— dioxolane).

For the synthesis of the triblock copolymers the linear bishydroxy-functional POM macroinitiator (0.55 g, 0.15 mmol) was placed in a Schlenk flask and suspended in benzene (10 wt %). Subsequently, the appropriate amount of cesium hydroxide was added to achieve 10% of deprotonation of the terminal hydroxyl groups. After stirring the mixture for 30 min, benzene was removed in vacuo at 60° C. overnight. Dimethylacetamide (DMAc) was added, and the mixture was heated to 140° C. to ensure complete dissolution of the macroinitiator. A 10 wt % solution of glycidol in DMAc was added slowly with a syringe pump over a period of approximately 24 h. The reaction was terminated with an excess of methanol and weak acidic cation exchange resin. The product was separated by centrifugation and washed with methanol three times to remove polyglycerol homopolymer. The resulting triblock copolymer was dried in vacuo for 2 days (yield: 58%). SEC (HFIP, PMMA-Std.): Mₙ=11 700 g mol⁻¹; PDI=1.96. ¹H NMR (HFIP-d₂, 600 MHz): δ [ppm]=5.15-5.00 (—CH₂— POM chain); 5.00-4.95 (—CH₂— dioxolane); 4.10-3.60 (—CH₂— dioxolane+hbPG backbone).

Synthesis of poly(oxymethylene) Nanoparticles

For the synthesis of the nanoparticles, 50 mg of the respective POM (co)-polymers were dissolved in 2 g of HFIP at 30° C. in an ultrasonication bath. Separately, 10 mg of the surfactant KLE was dissolved in 10 g cyclohexane at 40° C. in an ultrasonication bath. Both phases were mixed, pre-emulsified mechanically and sonified for 2 min under ice cooling using a ½ inch tip sonifier (5 s pulse, 10 s pause, 70% amplitude). The resulting miniemulsion was stirred for 30 min at 600 rpm in an open vial to evaporate the HFIP. Purification of excess surfactant was achieved by centrifugation of the nanoparticles and redispersion in pure cyclohexane. For redispersion in water, 0.5 g of the nanoparticle dispersion in cyclohexane was added to 10 g of an aqueous solution containing 10 mg of SDS and the two phase system stirred in an open vial for 4 h at 1400 rpm to evaporate the cyclohexane.

### Acid-Catalyzed Degradation of the Nanoparticles

To 1 mL of the redispersion of the nanoparticles in water 1 mL hydrochloric acid (5 mol L⁻¹) and 1 mL DMF were added and stirred at 80° C. for 1 hour. Then, the solution was centrifugated at 4500 rpm for 5 minutes.

### Film Formation

For film formation, the nanoparticle dispersion in cyclohexane (solid content of 1 wt %) was drop-casted onto a silicon wafer. Heating of the wafer for 10 s to 180° C. resulted in film formation of the POM-particles. To analyze the film consistency and thickness, the wafer was broken in half and investigated via SEM under various angles.

### Polymer Synthesis and Characterization.

The nonlinear hyperbranched-linear-hyperbranched ABA triblock copolymers based on hbPG and POM were synthesized via a combination of cationic ring-opening polymerization (ROP), followed by the multibranching anionic ROP of glycidol. In the first step, linear bishydroxy-functional poly(oxymethylene) (POM) copolymers were prepared by cationic ring-opening copolymerization of trioxane and 1,3-dioxolane with formic acid as a transfer agent. The resulting formiate end groups were hydrolyzed to obtain the bishydroxy end-functional POM. This serves as a difunctional macroinitiator for the ensuing hypergrafting reaction of glycidol resulting in nonlinear ABA triblock copolymers with an adjustable number of hydroxyl groups. The reaction sequence is as follows:

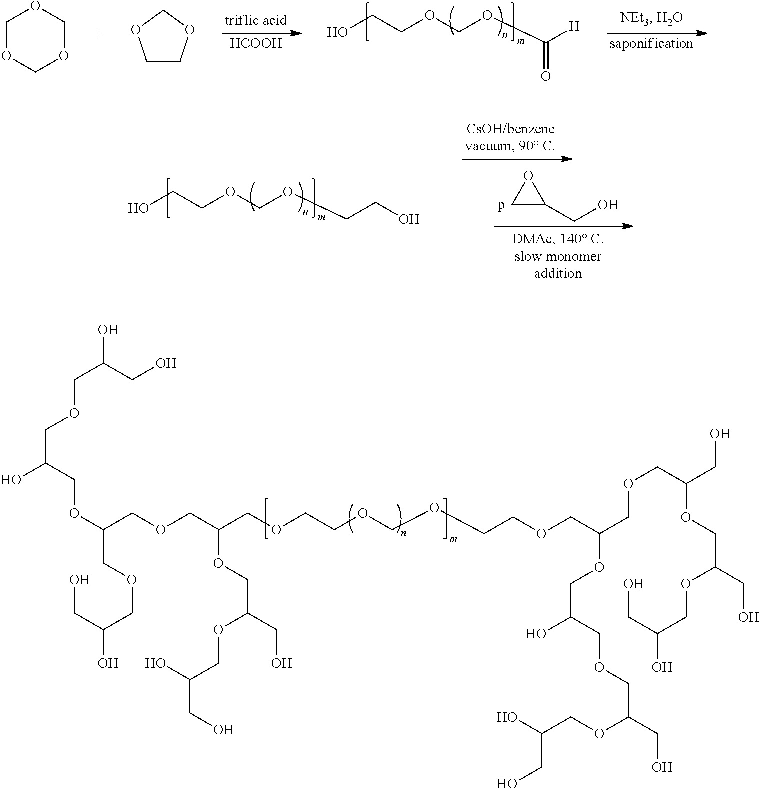

Table 1 shows the characterization data of the polymers that were used for nanoparticle formation obtained by NMR and SEC as well as their thermal properties determined by DSC.

TABLE 1
Characterization data for nonlinear copolymers.

| | | Mₙ^{a}/ | Mₙ^{b}/ | M_{w}/ | | |
|---|---|---|---|---|---|---|
| no. | composition (NMR) | g mol⁻¹ | g mol⁻¹ | Mₙ^{b} | Tₘ^{c} | T_{g}^{c} |
| 1 | POM₁₂₀ | 3 800 | 10 700 | 2.09 | 164.4 | — |
| 2 | hbPG₂-b-POM₁₂₀-b-hbPG₂ | 4 000 | 11 700 | 1.96 | 159.3 | −65.3 |
| 3 | hbPG₃-b-POM₁₂₀-b-hbPG₃ | 4 200 | 14 600 | 1.82 | 159.3 | — |
| 4 | hbPG₅-b-POM₁₂₀-b-hbPG₅ | 4 400 | 14 400 | 1.88 | 157.6 | −62.1 |
| 5 | hbPG₇-b-POM₁₂₀-b-hbPG₇ | 4 800 | 10 000 | 2.53 | 159.0 | −55.0 |

^{a}Calculated from ¹H NMR spectra.
^{b}Determined by SEC in HFIP (RI-detector signal, PMMA standards).
^{c}DSC data from second heating run, heating rate: 10 K min⁻¹.

The number-averaged molecular weight of the difunctional macroinitiator (1) was determined via ¹H NMR endgroup analysis. Integration of the resonances of the methylene signals stemming from ring-opened trioxane (at 5.10 ppm) and dioxolane (at 5.00 and 3.95 ppm) results in a Mₙ of 3 800 g mol⁻¹ SEC in HFIP vs. PMMA standards overestimates the molecular weights at ca. 10 kg mol⁻¹. After hypergrafting of glycidol new signals between 3.50 and 4.20 ppm corresponding to hbPG indicate the successful triblock copolymer formation.

The molecular weights (determined by NMR) of the resulting nonlinear triblock copolymers vary from 4 000 to 4 800 g mol⁻¹. SEC measurements determine apparent molecular weights in the range of 10 000 to 14 600 g mol⁻¹ and moderate polydispersities (M_{w}/Mₙ: 1.82-2.53).

Thermal properties were investigated via differential scanning calorimetry (DSC). The characteristic melting range of POM is detected between 175° C. and 185° C. (only trioxane as monomer) and around 165° C. for copolymers based on trioxane and dioxolane in strong dependence of the dioxolane content, while reported glass transition temperatures (T_{g}) are detected at −82° C. From the data in Table 1 a melting temperature (Tₘ) of 164.4° C. was detected for the macroinitiator (1) which is in the expected range. For the triblock copolymers the Tₘs decrease to values of 157.6 to 159.3° C. Additionally, a T_{g} is observable which increases from −65.3 to −55.0° C. with increasing hbPG content which lies in the intermediate region for pure POM and hbPG (with a typical T_{g} of ca. −20° C.).

### Nanoparticle Preparation

The solvent evaporation combined with the miniemulsion technique is a facile process to prepare polymer nanoparticles from previously synthesized materials by dissolving them in a good solvent for the polymer and dispersing this solution in a nonsolvent. After solvent evaporation, a polymer-nanoparticles dispersion is obtained. For the POM (co)polymers it was necessary to optimize this protocol due to the low solubility of POM in most organic solvents. Fluorinated solvents, such as HFIP can be used to dissolve POM and its copolymers. The POM (co)polymers are dissolved in HFIP and mechanical stirring is used to produce a pre-emulsion of HFIP/polymer droplets in a continuous cyclohexane phase. The emulsion was stabilized by a block copolymer comprised of a poly(ethylene oxide) block with M_{w}˜3 600 g mol⁻¹ and a poly(ethylene-co-butylene) block with M_{w}˜3 700 g mol⁻¹. The P(E/B) block prevents the droplets from coalescence by steric stabilization. Sonication of the two-phase system leads to the formation of miniemulsion droplets of HFIP containing the POM homo- and block copolymers. By stirring the miniemulsion in an open vial at room temperature, the good solvent HFIP was evaporated quickly due to the low boiling point of HFIP of ca. 58° C. After evaporation of HFIP, a nanoparticles dispersion of POM homo- and block copolymers in cyclohexane which was stable over a period of several months was obtained.

The diameter of the POM and hbPG-b-POM-b-hbPG nanoparticles was found to be in the range of 190-250 nm with a standard deviation of ˜30% by dynamic light scattering (DLS). The nanoparticle diameters all show similar sizes and no clear differences between the POM homopolymer and the POM block copolymers with hbPG segments can be observed. Thus, the size of the nanoparticles is independent of the number of hbPG-units at the ends, at least to an extent of 7 PG-units at each end.

TABLE 2
Hydrodynamic diameters of different
POM nanoparticles determined via DLS.

| | | Hydrodynamic | Standard |
|---|---|---|---|
| no. | composition (NMR) | diameter/nm | deviation |
| 1 | POM₁₂₀ | 220 | 28% |
| 2 | hbPG₂-b-POM₁₂₀-b-hbPG₂ | 250 | 27% |
| 3 | hbPG₃-b-POM₁₂₀-b-hbPG₃ | 190 | 38% |
| 4 | hbPG₅-b-POM₁₂₀-b-hbPG₅ | 210 | 26% |
| 5 | hbPG₇-b-POM₁₂₀-b-hbPG₇ | 200 | 21% |

Additionally, a redispersion of these nanoparticles in water was possible using an aqueous sodium dodecylsulfate (SDS) solution as surfactant (with subsequent dialysis) leading to a slight increase of the nanoparticles sizes (300-320 nm, standard deviation ˜42%, from DLS, probably due to swelling of the polymers in water.

To compare the sizes of the nanoparticles in solution and in dried state and to get an insight into the morphology of the POM homo- and block copolymers, SEM imaging of all samples was performed. The diameters from SEM are similar to the ones determined by DLS, however, the average diameter is slightly smaller. As expected, spherical nanoparticles are obtained, however, a perfect spherical shape is not always found and a slight anisotropy can be observed.

Additionally, the polyacetal structure of the POM-block makes these nanoparticles also interesting as degradable materials for various applications. The acid catalyzed degradation of the nanoparticles was studied with an aqueous dispersion. To this dispersion a small amount of hydrochloric acid was added as a proof of principle and the mixture was heated to 80° C. for one hour. After the centrifugation of this solution, no residue was observed revealing the full degradation of the nanoparticles. Therefore, different materials like pigments or drugs can be encapsulated and can be released after stimuli with acidic pH.

### Film Formation

For film formation, the particle dispersion was drop-casted on a silicon wafer and sintered at elevated temperatures. For the film formation, the particles have to be heated above the melting temperature (Tₘ), which is around 165° C. for pure POM. The surface of the formed films after heating to 180° C. for 10 s was investigated via SEM. After sintering a homogenous film is obtained, showing the feasibility of these nanoparticles to form smooth POM surfaces. The optical micrographs show the silicon wafer coated with hbPG₃-b-POM₁₂₀-b-hbPG₃ nanoparticles before and after sintering. Before sintering the surface is opaque resulting from the high crystallinity of POM and the accompanying color of the nanoparticles. After sintering the surface is transparent and colorless. This is favorable for applications, e.g., paints where the tuning of the color should be possible over the whole color range.

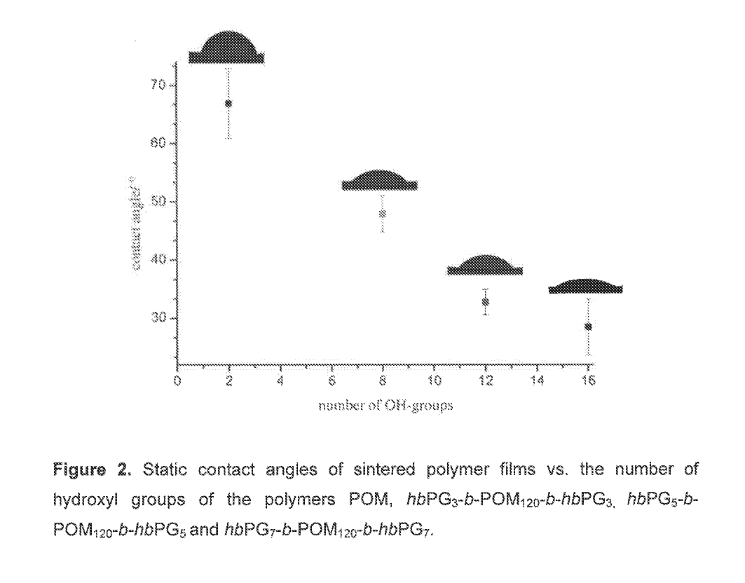

These films were investigated via static contact angle measurements at the liquid/vapor interface against water to analyze the influence of the hbPG-blocks on the film properties. The contact angles decreases from 67 to 29° for increasing hydroxyl groups from 2 to 16. FIG. 2 summarizes the contact angle vs. the number of hydroxyl groups of the polymers. A clear trend to lower contact angles with increasing number of hydroxyl groups is observable. The linear decrease in the contact angle indicates a homogenous film without any phase separation. The fast sintering of the nanoparticles does not allow the phase separation of the POM and hbPG in the film, as the hydroxyl groups of the hbPG-block are located at the surface of each nanoparticle. Therefore, the sintering process seems to be faster than the diffusion of the chains in the polymer melt. The adjustability of the hydrophilicity by varying the hbPG-block size and accompanying the number of hydroxyl groups opens manifold possibilities for the use of POM. In combination with the easy handling of the aqueous nanoparticles dispersions, this approach exhibits promising possibilities for POM as a very important engineering plastic, e.g., in shock proof-coatings.

These nanoparticles could be used for paints or coatings, where the excellent mechanical properties, like excellent impact and tensile strength, low friction coefficients, low abrasion and high resistance, of POM and the high hydrophilicity of hbPG are of great interest. Additionally, the sintering of these nanoparticles generates very thin POM films where the hydrophilicity can be tuned and further functionalization is possible.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. Polymer particles comprising polyoxymethylene nanoparticles, the nanoparticles having an average particle size of from about 20 nm to about 700 nm as measured by dynamic light scattering.

2. Polymer particles as defined in claim 1, wherein the nanoparticles consist of a polyoxymethylene polymer.

3. Polymer particles as defined in claim 1, wherein the nanoparticles comprise a polyoxymethylene polymer having a number average molecular weight of from about 500 g/mol to about 50,000 g/mol.

4. Polymer particles as defined in claim 1, wherein the nanoparticles comprise a polyoxymethylene copolymer.

5. Polymer particles as defined in claim 1, wherein the nanoparticles comprise a polyoxymethylene triblock copolymer.

6. Polyoxymethylene particles as defined in claim 5, wherein the polyoxymethylene triblock copolymer includes a middle portion between a first end portion and a second end portion, the first and second end portions comprising hyperbranched portions.

7. Polyoxymethylene particles as defined in claim 6, wherein the middle portion of the triblock copolymer comprises a linear structure having repeating oxymethylene units and optionally other oxyalkylene units, the first and second end portions including at least 10 branches per molecule and up to about 500 branches per molecule.

8. Polyoxymethylene particles as defined in claim 6, wherein the first and second end portions comprise hyperbranched polyglycerol.

9. A dispersion containing the polymer particles as defined in claim 1.

10. A dispersion as defined in claim 9, wherein the dispersion comprises an aqueous dispersion.

11. A process for producing polyoxymethylene nanoparticles comprising:
dissolving a polyoxymethylene polymer in a solvent to form a polyoxymethylene solution;
combining the polyoxymethylene solution with an emulsifying liquid to form an emulsion, the emulsifying liquid being immiscible with the solvent; and
evaporating the solvent to leave a dispersion containing polyoxymethylene nanoparticles.

12. A process as defined in claim 11, wherein the solvent comprises an alcohol.

13. A process as defined in claim 11, wherein the solvent comprises hexafluoro-2-isopropanol.

14. A process as defined in claim 11, wherein the emulsifying liquid comprises cyclohexane.

15. A process as defined in claim 11, wherein the emulsifying liquid contains an emulsifying agent.

16. A process as defined in claim 15, wherein the emulsifying agent comprises poly[(ethylene-co-butylene)-b-(ethylene oxide)].

17. A process as defined in claim 11, further comprising the step of redispersing the nanoparticles in water.

18. A process as defined in claim 11, further comprising the step of subjecting the combined polyoxymethylene solution and the emulsifying liquid to ultrasonic energy.

19. A process as defined in claim 11, wherein the polyoxymethylene polymer comprises a polyoxymethylene copolymer.

20. A process as defined in claim 11, wherein the polyoxymethylene polymer comprises a polyoxymethylene triblock copolymer.

21. A process as defined in claim 20, wherein the polyoxymethylene triblock copolymer includes a middle portion between a first end portion and a second end portion, the first and second end portions comprising hyperbranched portions.

22. A process as defined in claim 20, wherein the middle portion of the triblock copolymer comprises a linear structure having repeating oxymethylene units and optionally other oxyalkylene units, the first and second end portions including at least 10 branches per molecule and up to about 500 branches per molecule.

23. A process as defined in claim 20, wherein the first and second end portions comprise hyperbranched polyglycerol.
